(19) United States
(12) Patent Application Publication
(10) Pub. No.: US 2013/0297600 A1
(43) Pub. Date: Nov. 7, 2013

(54) METHOD AND SYSTEM FOR CHRONOLOGICAL TAG CORRELATION AND ANIMATION

(71) Applicants: Thierry Charles Hubert, Arlington, MA (US); Charles Todd Thompson, Deephaven, MN (US)

(72) Inventors: Thierry Charles Hubert, Arlington, MA (US); Charles Todd Thompson, Deephaven, MN (US)

(21) Appl. No.: 13/888,063

(22) Filed: May 6, 2013

Related U.S. Application Data
(60) Provisional application No. 61/642,772, filed on May 4, 2012.

(51) Int. Cl. G06F 17/30

(52) U.S. Cl. CPC G06F 17/30011
USPC 707/736

(57) ABSTRACT

Systems and methods for facilitating the comprehension and awareness of electronic content dynamically changing over time through the movement of tags across defined intervals are herein disclosed. The systems and methods include a fetching engine that requests the content using a web service; a chronological tag assembler that selects the documents from the time-stamped document repository for the defined intervals, and creates information associated with tags within the documents in tag tables; and a tag cloud canvas that accepts the tag table information from the chronological tag assembler, determines the placement of the tags in the tag cloud canvas using the tag table information, and renders animation of the tags in the tag cloud canvas to a display device.

### CROSS-REFERENCE TO RELATED APPLICATIONS

This application claims priority to U.S. Provisional Application No. 61/642,772, entitled “Temporal Cloud Motion Apparatus,” filed May 4, 2012, which is hereby incorporated herein in its entirety.

### FIELD OF THE INVENTION

The present disclosure relates to novel and advantageous systems and methods for animated presentation of correlated emerging terms or tags over a defined period of time.

### BACKGROUND

The advent of the rapid creation of content, for example, through the use of on-line social networks, and the limited use of search queries listing recently posted content in a chronological order, creates a need to improve the information consumption through innovative methods and technologies that are capable of lifting the burden of information overload, consumption and discovery.

Search engines are also limited by page ranking and social networks to offer results that are driven by popularly. This prevents the most recent information from being promptly displayed for consumption. Furthermore, the advent of micro-blogging sites, such as Twitter, offer a chronological listing of search queries that limit the results to the most recent information, and require the user to read through many irrelevant posts before discovering the information they are actually interested in or the trends worth noticing.

Today's search engines generally have page-ranking limitations for finding recent information. Further, the fast-paced nature of social content posting causes irrelevant content to occupy too much precious screen real-estate. Accordingly, a need exists for better system and methods for presenting information to a user of the internet.

### BRIEF SUMMARY OF THE INVENTION

The present disclosure relates to in one embodiment, a system for facilitating the comprehension and awareness of electronic content dynamically changing over time through the movement of tags across defined intervals, the system comprising: a fetching engine that requests the content using a web service, wherein the web service receives the content in documents, and saves the documents to a time-stamped document repository; a chronological tag assembler that selects the documents from the time-stamped document repository for the defined intervals, and creates information associated with tags within the documents in tag tables; and a tag cloud canvas that accepts the tag table information from the chronological tag assembler, determines the placement of the tags in the tag cloud canvas using the tag table information, and renders animation of the tags in the tag cloud canvas to a display device.

In some embodiments the information in the tag tables comprises a tag weight for each of the tags; an index associated with the documents that each tag is included within; and one or more correlated lists of the tags, wherein the correlated lists include the tags in common to one or more of the documents.

In some embodiments the tag cloud canvas includes predefined regions for determining the placement of the tags according to the correlation strength and cumulative weight of the tags.

Some embodiments my further include the tag cloud canvas rendering the animation between the defined intervals by resizing each tag according to the difference in weight of each tag, and repositioning each tag within the predefined regions of the tag cloud canvas based on the correlation strength of each tag.

In some embodiments the indication of each tag in the tag cloud canvas highlights one or more of the tags associated with the correlated lists of other tags in the tag cloud canvas which share an existence within the documents matching the indicated tag.

In still other embodiments, the content in the documents includes time-stamped records delimited by time intervals.

Also disclosed in the present disclosure is a method for facilitating the comprehension and awareness of electronic content dynamically changing over time through the movement of tags across defined intervals, comprising a fetching engine, a web service, a time-stamped document repository, a chronological tag assembler, tag tables, a tag cloud canvas, and a display device, the method. The method includes fetching engine requesting the content from the web service; receiving at a web server the content in documents, and saving the documents to the time-stamped document repository; selecting by the chronological tag assembler the documents from the time-stamped document repository for the defined intervals, and creating information associated with tags within the documents in the tag tables; and accepting by the tag cloud canvas the tag table information from the chronological tag assembler, determining the placement of the tags in the tag cloud canvas using the tag table information, and rendering animation of the tags in the tag cloud canvas to the display device.

In some embodiments the method further comprises calculating information for the tag tables, the method comprising calculating a tag weight for each of the tags, associating an index with the documents that each tag is included within, and creating one or more correlated lists of the tags that include the tags in common to one or more of the documents.

In some embodiments, determining the placement of the tags according to the correlation strength and cumulative weight of the tags in predefined regions of the tag cloud canvas.

In some embodiments the rendering includes rendering the animation between the defined intervals by resizing each tag according to the difference in weight of each tag, and repositioning each tag within the predefined regions of the tag cloud canvas based on the correlation strength of each tag.

In some embodiments indicating each tag in the tag cloud canvas highlights one or more of the tags associated with the correlated lists of other tags in the tag cloud canvas which share an existence within the documents matching the indicated tag.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive. In contrast, embodiments of methods described herein may improve the accuracy of the metric at diagnosing progression in the presence of tumor heterogeneity during treatment.

### BRIEF DESCRIPTION OF THE DRAWINGS

In the accompanying drawings, reference characters refer to the same parts throughout the different figures. The drawings are not necessarily to scale, emphasis has instead been placed upon illustrating the principles of embodiments of the present disclosure. With respect to the drawings:

FIG. 1 is a schematic diagram showing the information acquisition process and delivery mechanism of the correlated tag cloud for one interval, in accordance with some embodiments of the present disclosure;

FIG. 2 is a schematic diagram showing the animation mechanism between two tag cloud intervals, in accordance with some embodiments of the present disclosure; and

FIG. 3 is a screen shot of a working embodiment of a tag cloud canvas displayed on a device supporting an HTML application page, and that is complemented with timeline navigation features, and a list filtered of Twitter tweets as a type of document for the defined interval, and the demonstration of an indication of a tag resulting in a highlighted correlated tag cloud, and the demonstration of the tag cloud canvas predefined regions for the placement of the tags according to their correlation strength, in accordance with some embodiments of the present disclosure.

### DETAILED DESCRIPTION

The present disclosure is generally directed to using tag clouds, whereby users may visualize the relationships among the terms in the tag clouds. The present invention in some embodiments provides a new system for facilitating the comprehension and awareness of electronic content (“content”) dynamically changing over time through the movement of tags across defined intervals. Accordingly, in some embodiments information (or some portion of some information) may be provided to the user in animated form. This may be particularly advantageous as typically, semantic information that determines the relationships between two or more terms is static in nature. Providing such information in animated form may increase the speed at which users may consume information, understand links between information, identify information of interest, etc. Further, the overall experience of the user may be generally enhanced by providing information in a more interesting and interactive format.

A used herein, the term “tag” may describe a label attached to someone or something for identification or other purpose. A tag may be used in conjunction with text, image(s), video(s), animation, etc.

In one embodiment of the present disclosure, methods and systems may retrieve content using a web service, such as Twitter's tweet search API, for example, wherein the web service receives the content in time-stamped tweets. Such data may be stored in a repository for the construct of data tables capable of correlating and quantifying a collection of tags. Further, in some embodiments, the systems and methods may create information associated with tags within the documents in defined interval tag tables for a device to display a cloud canvas that accepts the tag table information to render animation of the tags in the tag cloud to a display device such as a web browser, mobile device, or tablet computer, for example. While use of embodiments of the present disclosure may be described with regard to Twitter tweets, other applications may also beneficially be used in conjunction with the present disclosure. For example instant messaging programs may also be used, or any other application or source of data that creates stings of data in time.

The animated tag cloud permits the user to observe the movement of tags and tag clusters associated with each other from a temporal perspective, thereby facilitating the understanding of emerging themes regarding a given topic of interest. This also permits the user to benefit from his or her own ability to recognize known and new terms that might grab his or her attention, thus facilitating a user-initiated discovery through pattern recognition over that of a machine inferred algorithm pointing out a specific result. A user of embodiments of the present disclosure may be free to select a tag to further reduce the scope of listed filtered records. It may be advantageous to the user's ability to gain awareness of the emerging themes developing in a body of evolving data and discover the most pertinent records to the user's selection. The animated presentation generally appeals to the innate human cognitive ability to scan and select items of import or interest from movement and relative placement or displacement.

One embodiment of the present disclosure provides a system for using information that has been curated, organized and delivered by a system which delivers the data-set that provides the correlated emerging terms and their relative weight in temporal intervals. Embodiments of the present disclosure may then render the results in an animated presentation. In some embodiments, the animated presentation of information may be accomplished by using different programming platforms supporting animation for machine specific devices, such as JavaScript, Adobe Flash, HyperText Markup Language, for example.

In some embodiments, the information stored in the tag tables may contain the weight of each tag and the correlated tags providing the presentation aspect of the invention with the necessary information to place and animate the tags according to their relationship and importance in a dedicated area on the tag cloud canvas to facilitate the detection of importance for the user, in some embodiments, or for systems to perform other analysis, in other embodiments.

As another aspect of embodiments of the present disclosure include the tag tables' value may change from one interval to another to allow for the system to render the transition animation from one set of values to another according to the different tag weights and tag correlation strength, for example.

In another embodiment, a user or a system's indication of a tag may be used to reveal other tags in the tag cloud canvas that share an existence within the documents matching the indicated tag, and in some cases may further be used to reveal the documents related to the indication's filter in a document list.

According to yet another embodiment, the tag tables may be representative of time-delimited intervals that provide a cumulative historical snapshot of the context through the tags' correlation and weight for a rapid and statistical assessment of the general strength of the context without a subsequent dependence on the documents.

Another embodiment of the present disclosure provides such a system wherein tag cloud intervals can be accessed from a time-slider for replay and whereby the scale of the time interval may be changed to further concatenate the interval in higher or less granularity of data.

A further embodiment of the present disclosure provides such a system wherein the system is capable of matching the correlated terms with a distant record, matching the entire or some of the terms. This embodiment could be used to display advertisement(s) that matches the term(s) which are visible as a matching search query, for example.

In some embodiments a method is disclosed for presenting to a user an animated tag cloud and its related record lists that are correlated through shared and cross-referenced tags assigned to each record through various extraction methods; herein the tags are highlighted upon pointing device selection or API to outline their correlation; herein the tags are assigned to a distinct style using colors, text underlining, text background colors, text boxes or other distinctive representation; wherein the user's selection of a tag causes the correlated tag cloud keywords be highlighted; wherein the user's selection of a tag causes to filter the record list(s) with presenting only the records associated with the highlighted tag selection; wherein the selection of listed record opens the record's source through a Uniform Resource Locator (“URL”) or other reference locator as defined by the record source and/or defined alternative subsequent action.

An “indication” indicates the selection of a tag with a device by means of a pointing device such as a mouse click, or a touch screen selection.

A “highlight” indicates the visual distinction of tags associated with the indication of a tag such has giving the highlighted term a specific color or bold effect that contrasts the highlighted tags with the non-highlighted tags

The “cluster” indicates a group of tags related to each other according their existence in shared documents, and displayed in relative proximity of each other, and/or highlighted according to the indication of one tag.

The “tag weight” indicates the number of times that each tag appears in all of the documents for a defined interval.

The “tag's correlated strength” indicates the number of connections to other tags related to the documents selected for a defined interval, and the cumulative tag weight of each correlated tag in the connected cluster.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

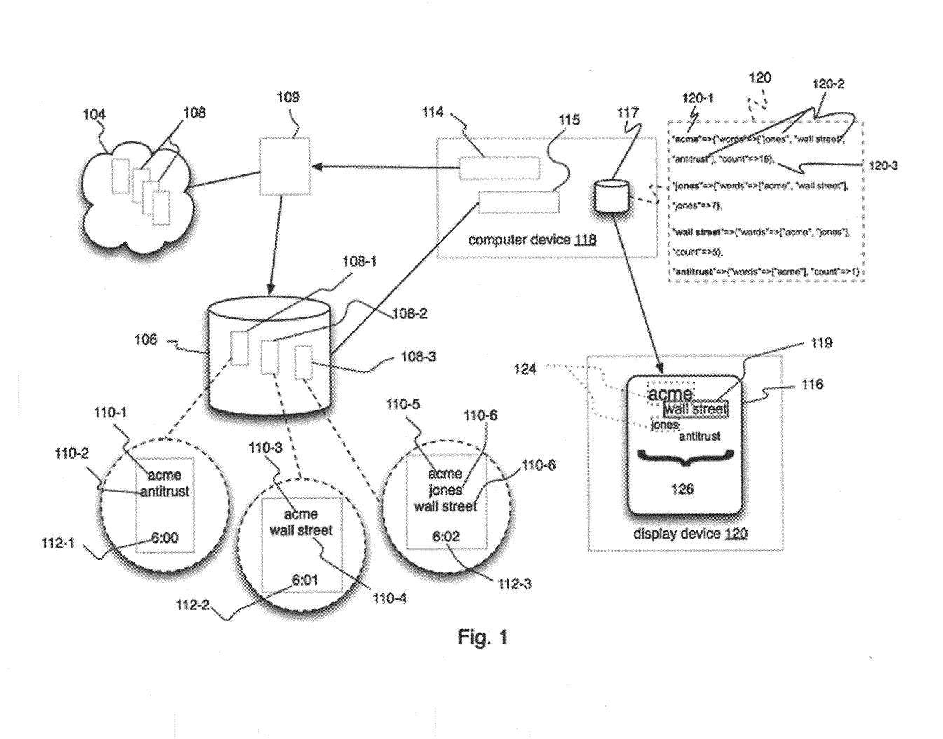

FIG. 1 shows the information acquisition process and delivery mechanism of the correlated tag cloud for one interval, according to some embodiments. Documents 108 such as an HTML page, twitter “tweets,” or an RSS feed are included within a network cloud 104. A computer device 118, such as a tablet, smartphone, or a computer workstation, for example may include a chronological tag assembler 115 and a fetching engine 114, for example. A display device 120 may connect to the computer device 118. Users may submit a query including terms of interest to the fetching engine 114, which submits a request to a search service 109. Example search services 109 include the Twitter search API, a Google RSS search query for news or blog events, or any other suitable service, application, or data repository.

In response, the search service 109 may provide a structured list of documents 108-1, 108-2, and 108-3 associated with the user's query criteria to a time-stamped document repository 106. Each of the documents 108 may include terms 110 and timestamp information 112.

The chronological tag assembler 115 may select the documents 108 from the time-stamped document repository 106 for a defined interval. Then, the chronological tag assembler 115 may process the documents 108, and display information associated with the documents 108 onto a tag cloud canvas 116 that renders on the display device 120.

In some embodiments, the chronological tag assembler 115 creates one or more tag tables 117 from the terms 110 within the documents 108 for the defined interval. The tag tables 117 include information such as an index that identifies the document 108 for each term 110, what terms 110 are associated with each other based on their shared existence in one or more documents 108, and the number of times each term 110 appears across all documents 108.

The tag tables 117, in some embodiments, are constructed to include the term's correlation for a given interval 120. The tag table is defined to include each tag 120-1 and their correlated keywords 120-2 and the count 120-3 of the cumulative tags' occurrences in the correlated cluster to deliver the values and relationships needed for the tag cloud canvas' 116 animation, in some embodiments.

The tag cloud canvas 122 may retrieve the information from the tag tables 117 and render the tag cloud canvas 116 from the information to the display device 120. Within the tag cloud canvas, the terms 110 have been transformed into weighted and correlated tags 126, in some embodiments.

In the example, term “acme” appears in 110-1, 110-2, and 110-3, and as a result, appears larger than the other tags 126.

To illustrate the correlation aspect of the invention, the user indicates tag “wall street” 119 from the tags 126. In response to the indication, tags “acme” and “jones” 124 are highlighted, which indicates that the tags 124 share documents 108-2 and 108-3 with the tag “wall street” 126, respectively. Current tag clouds do not display or convey correlations among tags 126 related to shared documents 108.

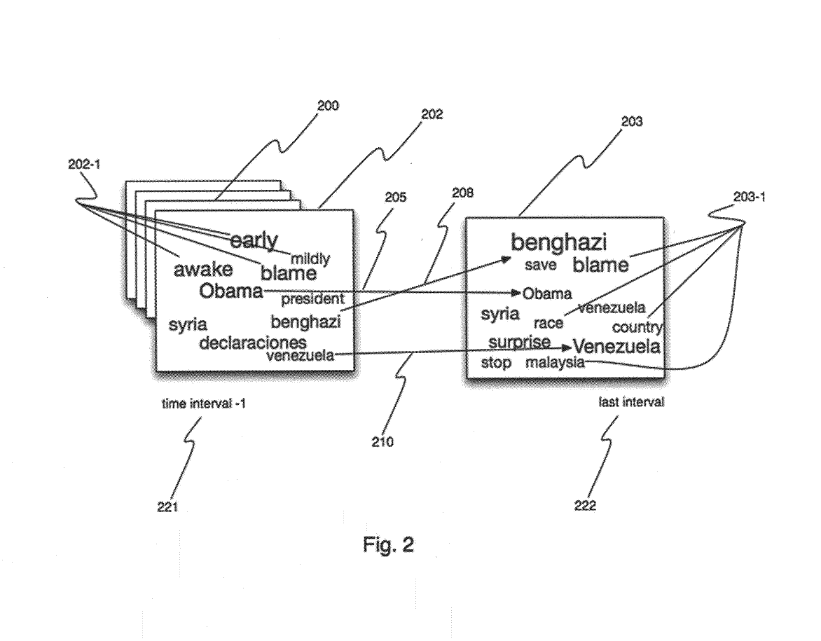

FIG. 2 shows the animation mechanism between two sequential tag cloud canvas 116 intervals 200. The tag cloud canvases 116 are stacked as distinct chronological intervals 200 such as an XML data structure to be utilized by a display device 120 equipped with the tag cloud canvas 116, according to some embodiments.

The tag cloud canvas 202 displays the tags associated with a prior time interval 221, whereas the tag cloud canvas 203 displays the tags associated with the last interval 222. Some of the same tags in the tag cloud canvas 202 and tag cloud canvas 203 have different weight and positions, other tags 202-1 originating from the tag cloud canvas 202 have disappeared in the tag cloud canvas 203 and others tags 203-1 have appeared in the tag cloud canvas 203.

The animation of the tags may be displayed during tag transition 205, 208 and 2010 between the tag cloud canvas 202 and 203.

The transition 205 shows that the tag “Obama” shrinks from the tag cloud canvas 202 and 203 due to a reduction of the tag's weight from the 221 interval and 222 interval, likewise the position of the “Obama” tag remains in the same placement area in the tag cloud canvas 203 due to a minimal change in its correlated strength versus other tags.

The transition 208 shows that the tag “benghazi” grows from the tag cloud canvas 202 and 203 due to an increased value of the tag's weight from the 221 interval and 222 interval, likewise the position of the “benghazi” tag is in a new placement area in the tag cloud canvas 203 due to a significant change in its correlated strength relative to other tags.

The transition 210 shows that the tag “venezuela” grows from the tag cloud canvas 202 and 203 due to an increased value of the tag's weight from the 221 interval and 222 interval, likewise the position of the “venezuela” tag is in a slightly new placement area in the tag cloud canvas 203 due to a moderate change in its correlated strength with other tags.

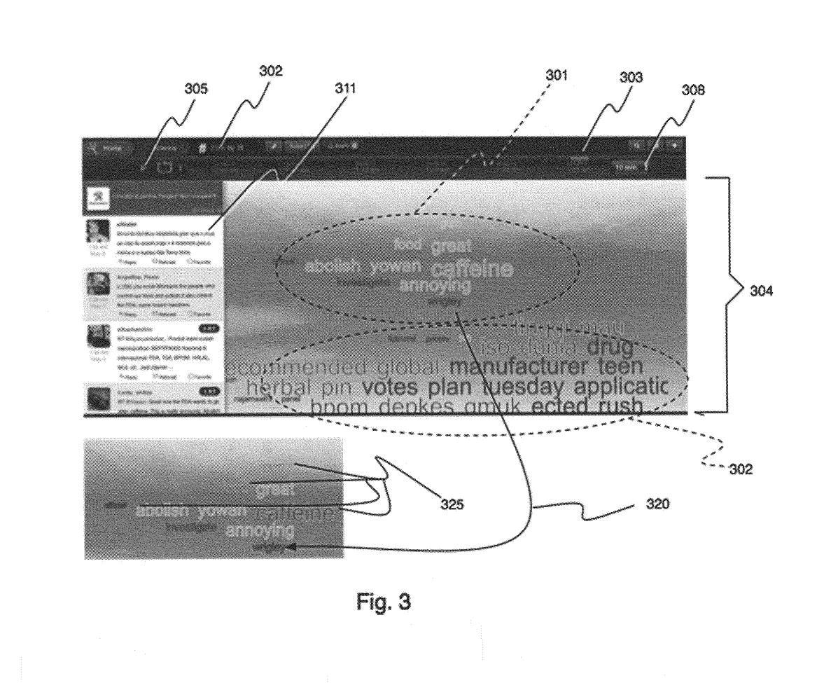

FIG. 3 shows a working embodiment of a tag cloud canvas 304 with predefined regions 301 and 302, and a declared query filter “FDA” 302, and a time line navigation tool bar 303 for the user to select a tag cloud canvas 116 interval displayed on the line navigation tool bar 303, and for the user to select an interval scale 308, and for a list of filtered documents 311 for the interval 303 to be displayed.

FIG. 3 shows the correlated tag highlight 325 resulting from the indication of the tag “wrigley” 320. The predefined region 301 shows the placement of a cluster of correlated tags with the higher correlated strength, according to embodiments of the present disclosure. The predefined region 302 shows all other tags with lesser correlated strength to the predefined region 301 in a lower position than the tags placed in the predefined region 301.

Upon reading this disclosure, those skilled in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system for facilitating the comprehension and awareness of electronic content dynamically changing over time through the movement of tags across defined intervals, the system comprising:
a fetching engine that requests the content using a web service, wherein the web service receives the content in documents, and saves the documents to a time-stamped document repository;
a chronological tag assembler that selects the documents from the time-stamped document repository for the defined intervals, and creates information associated with tags within the documents in tag tables;
a tag cloud canvas that accepts the tag table information from the chronological tag assembler, determines the placement of the tags in the tag cloud canvas using the tag table information, and renders animation of the tags in the tag cloud canvas to a display device.

2. The system of claim 1, wherein the information in the tag tables comprise:
a tag weight for each of the tags;
an index associated with the documents that each tag is included within; and
one or more correlated lists of the tags, wherein the correlated lists include the tags in common to one or more of the documents.

3. The system of claim 1, wherein the tag cloud canvas includes predefined regions for determining the placement of the tags according to the correlation strength and cumulative weight of the tags.

4. The system of claim 3, wherein the tag cloud canvas renders the animation between the defined intervals by resizing each tag according to the difference in weight of each tag, and repositioning each tag within the predefined regions of the tag cloud canvas based on the correlation strength of each tag.

5. The system of claim 1, wherein indication of each tag in the tag cloud canvas highlights one or more of the tags associated with the correlated lists of other tags in the tag cloud canvas which share an existence within the documents matching the indicated tag.

6. The system of claim 1, wherein the content in the documents includes time-stamped records delimited by time intervals.

7. A method for facilitating the comprehension and awareness of electronic content dynamically changing over time through the movement of tags across defined intervals, comprising a fetching engine, a web service, a time-stamped document repository, a chronological tag assembler, tag tables, a tag cloud canvas, and a display device, the method comprising:
fetching engine requesting the content from the web service;
receiving at a web server the content in documents, and saving the documents to the time-stamped document repository;
selecting by the chronological tag assembler the documents from the time-stamped document repository for the defined intervals, and creating information associated with tags within the documents in the tag tables; and
accepting by the tag cloud canvas the tag table information from the chronological tag assembler, determining the placement of the tags in the tag cloud canvas using the tag table information, and rendering animation of the tags in the tag cloud canvas to the display device.

8. The method of claim 7, further comprising calculating information for the tag tables, the method comprising calculating a tag weight for each of the tags, associating an index with the documents that each tag is included within, and creating one or more correlated lists of the tags that include the tags in common to one or more of the documents.

9. The method of claim 7, further comprising determining the placement of the tags according to the correlation strength and cumulative weight of the tags in predefined regions of the tag cloud canvas.

10. The method of claim 9, further comprising rendering the animation between the defined intervals by resizing each tag according to the difference in weight of each tag, and repositioning each tag within the predefined regions of the tag cloud canvas based on the correlation strength of each tag.

11. The method of claim 7, wherein indicating each tag in the tag cloud canvas highlights one or more of the tags associated with the correlated lists of other tags in the tag cloud canvas which share an existence within the documents matching the indicated tag.
